(19) United States
(12) Patent Application Publication
(10) Pub. No.: US 2011/0151216 A1
(43) Pub. Date: Jun. 23, 2011

(54) Cast Power Stretch Films With Improved Load Containment Force

(75) Inventor: Shaun Eugene Pirtle, Coweta, OK (US)

(73) Assignee: Paragon Films, Inc., Broken Arrow, OK (US)

(21) Appl. No.: 12/969,738

(22) Filed: Dec. 16, 2010

Related U.S. Application Data
(60) Provisional application No. 61/287,775, filed on Dec. 18, 2009.

(51) Int. Cl. B32B 27/32; B32B 7/02; C08F 4/42; C08L 23/14; C08L 23/12; C08L 23/08; C08L 23/06

(52) U.S. Cl. 428/213; 428/521; 428/519; 526/183; 525/240

(57) ABSTRACT

The present disclosure generally relates to compositions and methods for incorporating higher density metallocene linear low density polyethylene (m-LLDPE) into cast power stretch films. When compared to conventional machine films on a gauge-by-gauge basis, films containing the properly selected m-LLDPE may offer increased load containment force, reduced application force, and comparable elongation and puncture resistance properties.

### CROSS-REFERENCES TO RELATED APPLICATIONS

This patent application claims the benefit of U.S. Provisional Patent Application Ser. No. 61/287,775, filed on Dec. 18, 2009, the contents of which are hereby incorporated by reference in their entirety.

### FIELD OF THE DISCLOSURE

The present disclosure generally relates to compositions and methods for producing cast power stretch films with improved load containment force. Such films are also resistant to punctures and may be stretched to high levels of elongation before reaching the point of ultimate elongation or failure. In particular, the present disclosure relates to the incorporation of higher density metallocene linear low density polyethylene (m-LLDPE) in cast power stretch films.

### BACKGROUND OF THE DISCLOSURE

Stretch films are widely used in a variety of bundling and packaging applications. For example, machine-applied cast power stretch films (i.e., machine films) are a common method of securing bulky loads such as boxes, merchandise, produce, equipment, parts, and other similar items on pallets. The level of containment force applied to the load is critical to ensure that the load is properly secured to the pallet. The “load containment force” is the residual level of force that is being applied to the load after the film has been allowed to relax for a prescribed length of time. For example, a heavier or larger load may require a higher load containment force in order to prevent shifting of the product on the pallet or product damage. The required level of load containment force is bracketed between an upper range where excessive force could potentially deform the product and an insufficient level of force resulting in a loss of containment due to film relaxation.

The load containment force is introduced into the film via the rotation of the load or the rotation of the film-dispensing unit, depending on the type of equipment used, while drag or braking is applied to the film roll as it is unwound. The level of available force is a function of the inherent properties of the film in relation to the specific elongation of the film achieved during the stretching process. These inherent properties include, but are not limited to, extensibility, how far the film can be stretched before it breaks (i.e., ultimate elongation), how much force is required to stretch the film at a prescribed level of elongation (i.e., force-to-stretch), and how much residual force is left in the film after the film has been applied to the load. These properties are influenced by factors such as the type, molecular weight, and density of the resin or resins comprising the film, the number of layers in the film, the relative percentage of each layer and how the layers are combined, the overall gauge of the film, and fabrication variables such as draw down ratio and quench rate. Secondary factors that may affect film performance include, but are not limited to, the type and geometry of the load being wrapped, the speed at which the film is unwound and the percent of elongation (i.e., deformation rate), the type of equipment used to wrap the load, the amount of slippage of the film as it is stretched, and any film deformities that could lead to premature failure.

In order to significantly increase the load containment force of a conventional machine film, an end-user may use more film, either by wrapping additional layers of film around a load or selecting a thicker film. Alternatively, an end-user may stretch the film to a point near its ultimate elongation point. However, stretching a film until it is near its ultimate elongation point imparts high levels of stress and orientation to the film. As a result, the film is vulnerable to defects, abuse, and excessive stretching and may be more likely to fail.

The inherent properties and fabrication parameters of the film dictate how much elongation and load containment force are possible before the film reaches the point of failure. Conventional machine films (e.g., films with an elongation level greater than or equal to 250 percent with good puncture and tear resistance) are typically produced from a broad range of Ziegler Natta (ZN) and/or metallocene catalyzed polyethylenes. The resins used in such films are selected for their inherent properties, which include high elongation and good load containment force as well as adequate resistance to punctures and tears. In order to provide this balance of properties, the melt index (g/10 min. @ 190° C./2.16 kg) of the selected resins may vary from 2 to 4. The density of the selected resins may vary from 0.915 g/cm³ to 0.919 g/cm³. However, for structures that utilize these types of resins, the load containment force may decrease by as much as 20 percent in ten minutes following the initial application. ZN-catalyzed resins with higher densities may be used to increase the load containment force of a film; however, such resins may significantly decrease the film's other performance properties, including ultimate elongation and puncture resistance.

As can be seen, there is a need for compositions and methods which produce films with increased load containment force while maintaining or improving the film's other performance properties. There is also a need for compositions and methods which reduce load containment decay over time.

### SUMMARY OF THE DISCLOSURE

The present disclosure provides a cast power stretch film that is comprised of a higher density m-LLDPE. The higher density m-LLDPE may be blended with other resins chosen from the group consisting of polyethylenes, polyethylene copolymers, polypropylenes, and polypropylene copolymers.

The present disclosure also provides a cast power stretch film comprised of five layers. A discrete layer of the film may be comprised of a higher density m-LLDPE. Resins that may be blended with the higher density m-LLDPE include, but are not limited to, polyethylenes, polyethylene copolymers, polypropylenes, and polypropylene copolymers.

These and other features, aspects, and advantages of the present disclosure will become better understood with reference to the following drawings, description, and claims.

### BRIEF DESCRIPTION OF THE DRAWINGS

The disclosure will be better understood from the following description and the accompanying drawings given as non-limiting examples, and in which:

FIG. 1 illustrates the load containment force exerted by selected conventional films and an embodiment disclosed herein; and

FIG. 2 illustrates the resistance to puncture for selected conventional films and an embodiment disclosed herein.

### DETAILED DESCRIPTION

The following detailed description is of the best currently contemplated modes of carrying out the disclosure. The description is not to be taken in a limiting sense, but is made merely for the purpose of illustrating the general principles of the disclosure, since the scope of the present disclosure is best defined by the appended claims.

Films containing higher density m-LLDPE may be produced which provide excellent performance with regards to load containment force, ultimate elongation, and puncture resistance. Films with higher density m-LLDPE may provide several advantages over conventional machine films. These advantages may include, but are not limited to: (1) requiring less film on a weight-to-weight basis to achieve the same level of load containment force; (2) applying less force to wrap the load while achieving the same load containment force; (3) significantly reducing load containment decay over time; (4) reducing liability due to product damage from crushing, deformation, or loss of containment; and (5) achieving higher levels of load containment force at lower levels of elongation, resulting in less film stress and fewer film failures.

Thus, when compared to conventional machine films on a gauge-by-gauge basis, films incorporating a higher density m-LLDPE may improve load containment force while offering comparable ultimate elongation and puncture resistance properties. In addition, the incorporation of a higher density m-LLDPE may significantly reduce load containment decay, or the amount of load containment force that is lost in the first twenty minutes after the load is wrapped. This feature may allow less force to be applied to wrap the load or, if the same amount of force is applied, provide a higher sustainable level of containment.

Broadly, the current disclosure includes compositions and methods for producing cast power stretch films with improved load containment force. More specifically, according to one aspect of the disclosure, a m-LLDPE having a higher density than that of resins used for conventional machine films may be incorporated into the film. The higher density m-LLDPE may provide for a film with properties, such as ultimate elongation and puncture resistance, which are comparable to those of conventional machine films. In addition, the film may offer increased load containment force and reduced load containment decay, allowing a corresponding reduction in the amount of force that must be applied to wrap a load.

The film of the present disclosure may be comprised of one layer or multiple layers, and the composition of each layer may vary. Materials that may be used to produce the film layers may include, but are not limited to, m-LLDPE, ZN-catalyzed linear low density polyethylene (LLDPE), polyethylenes, polyethylene copolymers, polyethylene terpolymers, polyethylene blends, polypropylenes, metallocene catalyzed polypropylenes, polypropylene copolymers, and blends thereof.

An embodiment of the present disclosure may be a film with a discrete layer comprised of a higher density m-LLDPE. The thickness of the discrete layer may vary from 5 to 70 percent of the total film thickness, with a preferred thickness of approximately 32 percent. The melt index of the m-LLDPE selected for the discrete layer may range from 0.5 to 8.0 (g/10 min. @ 190° C./2.16 kg), with a preferred melt index ranging from 1.0 to 3.0 (g/10 min. @ 190° C./2.16 kg). As an alternative, the preferred melt index may be approximately 2.0 (g/10 min. @ 190° C./2.16 kg). The density of the m-LLDPE selected for the discrete layer may range from 0.900 g/cm³ to 0.960 g/cm³, with a preferred melt index ranging from 0.922 g/cm³ to 0.940 g/cm³. As an alternative, the preferred density may be approximately 0.925 g/cm³. The m-LLDPE may also be combined with other resins, including, but not limited to, other polyethylenes, polyethylene copolymers, polypropylenes, and polypropylene copolymers. The discrete layer may be comprised of a polymer produced using a higher alpha-olefin comonomer.

The remaining layers of the film may be resins comprised of polyethylene, polyethylene copolymers, metallocene catalyzed polypropylenes, polypropylene copolymers, or blends thereof. Depending upon the desired properties of the film, the layers of the film may or may not have the same composition. The melt index of the resin selected for the remaining layers may range from 0.5 to 12 (g/10 min. @ 190° C./2.16 kg), with a preferred melt index ranging from 3 to 5 (g/10 min. @ 190° C./2.16 kg). The density of the resin selected for the remaining layers may range from 0.850 g/cm³ to 0.960 g/cm³, with a preferred density of approximately 0.917 g/cm³.

Another embodiment of the disclosure may be a five-layer film comprised of the following: a layer comprised of ZN-catalyzed LLDPE, with a thickness of approximately 10 percent of the total film thickness; a layer comprised of conventional m-LLDPE, with a thickness of approximately 32 percent of the total film thickness; a layer comprised of ZN-catalyzed LLDPE, with a thickness of approximately 16 percent of the total film thickness; a layer comprised of higher density m-LLDPE, with a thickness of approximately 32 percent of the total film thickness; and a layer comprised of ZN-catalyzed LLDPE, with a thickness of approximately 10 percent of the total film thickness.

The layer comprised of higher density m-LLDPE may vary from 5 to 70 percent of the total film thickness, with a preferred thickness of approximately 32 percent. The melt index of the higher density m-LLDPE may range from 0.5 to 8.0 (g/10 min. @190° C./2.16 kg), with a preferred melt index ranging from 1.0 to 3.0 (g/10 min. @ 190° C./2.16 kg). As an alternative, the preferred melt index may be approximately 2.0 (g/10 min. @ 190° C./2.16 kg). The density of the higher density m-LLDPE may range from 0.900 g/cm³ to 0.960 g/cm³, with a preferred density ranging from 0.922 g/cm³ to 0.940 g/cm³. As an alternative, the preferred density may be approximately 0.925 g/cm³. The higher density m-LLDPE may also be combined with other resins, including, but not limited to, other polyethylenes, polyethylene copolymers, polypropylenes, and polypropylene copolymers. The discrete layer may be comprised of a polymer produced using a higher alpha-olefin comonomer.

The remaining layers of the film may be resins comprised of polyethylene, polyethylene copolymers, metallocene catalyzed polypropylenes, polypropylene copolymers, or blends thereof. Depending upon the desired properties of the film, the layers of the film may or may not have the same composition. The melt index of the resin or resins selected for the remaining layers may range from 0.5 to 12 (g/10 min. @ 190° C./2.16 kg), with a preferred melt index ranging from 2 to 5 (g/10 min. @ 190° C./2.16 kg). The density of the resin or resins selected for the remaining layers may range from 0.850 g/cm³ to 0.960 g/cm³, with a preferred density of approximately 0.917 g/cm³.

As an experiment, selected performance properties of four films containing different resins, including a higher density m-LLDPE, were tested. Each test was run on an 80-gauge five-layer film, using the same production line and the same process conditions. The structure of each film was identical except for one layer, which represented 32 percent of the total film thickness. For Film A, the layer was comprised of Resin A, a conventional ZN-catalyzed solution octene. For Film B, the layer was comprised of Resin B, a conventional ZN-catalyzed gas phase hexene. For Film C, the layer was comprised of Resin C, a conventional metallocene. For Film D, the layer was comprised of Resin D, a higher density m-LLDPE as described in an embodiment of the disclosure. Table 1 describes the density and melt index of each resin:

| | Resin A | Resin B | Resin C | Resin D |
|---|---|---|---|---|
| Density | 0.926 | 0.924 | 0.917 | 0.925 |
| Melt index | 2.0 | 1.9 | 4.0 | 2.0 |

The density of each resin was determined in accordance with the methods and procedures of ASTM D792 and is expressed in units of g/cm³. The melt index for each film was determined in accordance with the methods and procedures of ASTM D1238 and is expressed in units of g/10 min. @ 190° C./2.16 kg.

Table 2 presents data comparing the results of selected analyses for the four films:

| | Film A | Film B | Film C | Film D |
|---|---|---|---|---|
| Load containment force | 91 | 88 | 82 | 94 |
| Resistance to puncture | 9.5 | 10.8 | 14.6 | 13.5 |

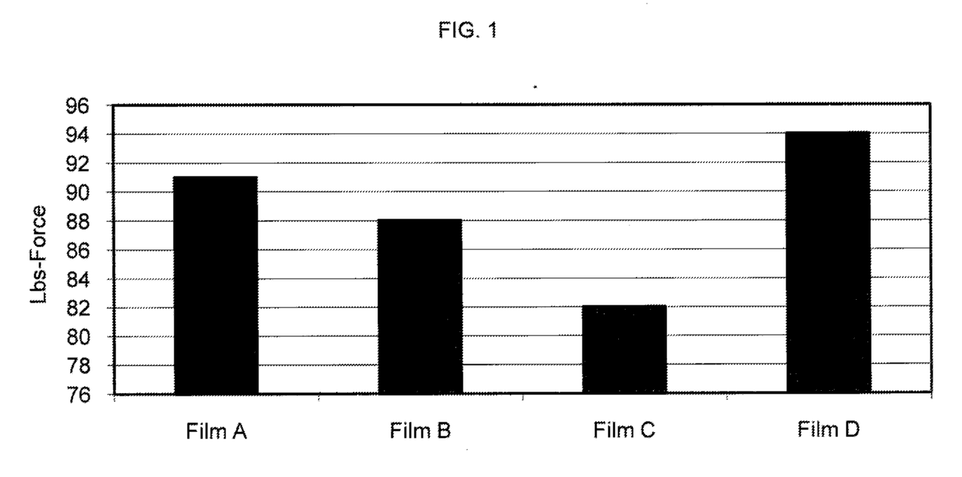

The load containment force was determined by pre-stretching the film 270 percent and applying five revolutions of film onto the test cube with a force-to-load of 20 pounds. The values are expressed in units of lbs-force. As shown in Table 2 and FIG. 1, Film D offers higher load containment force than the conventional ZN films (Film A and Film B) or the conventional metallocene film (Film C).

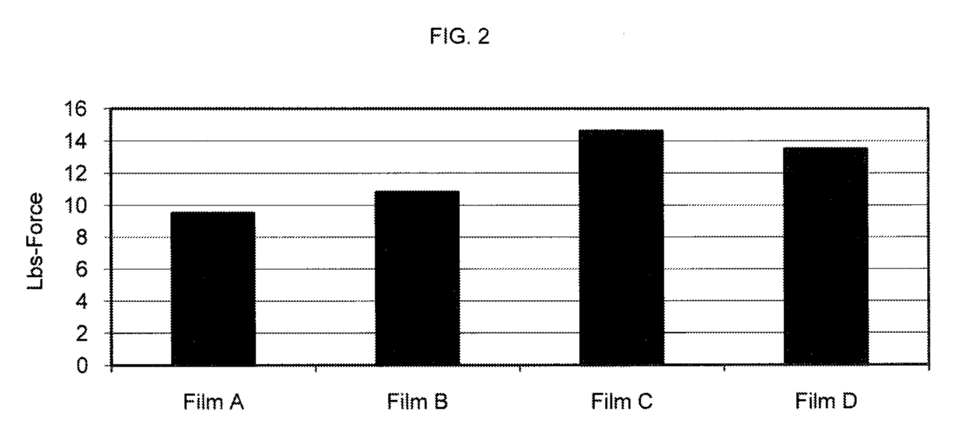

The resistance to puncture describes the force necessary to pierce or create a hole in the film. The values were generally determined in accordance with the methods and procedures of ASTM 5748 and are expressed in units of lbs-force. As shown in Table 2 and FIG. 2, Film D has the second highest resistance to puncture, after the conventional metallocene film (Film C).

When comparing the overall performance of the films, Film D offers the highest load containment force. In addition, Film D is much more resistant to punctures than either of the conventional ZN films (Film A and Film B). Although the conventional metallocene film (Film C) is more resistant to punctures than Film D, Film C has the overall lowest load containment force. Therefore, depending upon the desired use of the film, Film D likely offers the best combination of properties.

As can be seen, the present disclosure provides compositions and methods for producing a cast power stretch film with improved load containment force, reduced application force, and excellent elongation and puncture resistance properties. In particular, the present disclosure relates to the incorporation of higher density m-LLDPE in such films.

From the foregoing, it will be understood by persons skilled in the art that compositions and methods for producing a cast power stretch film have been provided. While the description contains many specifics, these should not be construed as limitations on the scope of the present disclosure, but rather as an exemplification of the preferred embodiments thereof. The foregoing is considered as illustrative only of the principles of the present disclosure. Further, because numerous modifications and changes will readily occur to those skilled in the art, it is not desired to limit the present disclosure to the exact methodology shown and described, and accordingly all suitable modifications and equivalents may be resorted to, falling within the scope of the present disclosure. Although this disclosure has been described in its preferred form with a certain degree of particularity, it is understood that the present disclosure of the preferred form has been made only by way of example and numerous changes in the details of the method may be resorted to without departing from the spirit and scope of the present disclosure.

What is claimed is:

1. A cast power stretch film comprised of a higher density m-LLDPE, the cast power stretch film having a total film thickness.

2. The cast power stretch film according to claim 1, wherein the higher density m-LLDPE is blended with resins chosen from the group consisting of polyethylenes, polyethylene copolymers, polypropylenes, and polypropylene copolymers.

3. The cast power stretch film according to claim 1, wherein the film is comprised of a plurality of discrete layers.

4. The cast power stretch film according to claim 3, wherein a discrete layer of the film is comprised of the higher density m-LLDPE.

5. The cast power stretch film according to claim 4, wherein the discrete layer of the film that is comprised of the higher density m-LLDPE has a thickness ranging from 5 to 70 percent of the total film thickness.

6. The cast power stretch film according to claim 5, wherein the discrete layer of the film that is comprised of the higher density m-LLDPE has a thickness of approximately 32 percent of the total film thickness.

7. The cast power stretch film according to claim 1, wherein the higher density m-LLDPE has a melt index ranging from 0.5 to 8.0 (g/10 min. @ 190° C./2.16 kg).

8. The cast power stretch film according to claim 7, wherein the higher density m-LLDPE has a melt index ranging from 1.0 to 3.0 (g/10 min. @ 190° C./2.16 kg).

9. The cast power stretch film according to claim 7, wherein the higher density m-LLDPE has a melt index of approximately 2.0 (g/10 min. @ 190° C./2.16 kg).

10. The cast power stretch film according to claim 1, wherein the higher density m-LLDPE has a density ranging from 0.900 g/cm³ to 0.960 g/cm³.

11. The cast power stretch film according to claim 10, wherein the higher density m-LLDPE has a density ranging from 0.922 g/cm³ to 0.940 g/cm³.

12. The cast power stretch film according to claim 10, wherein the higher density m-LLDPE has a density of approximately 0.925 g/cm³.

13. The cast power stretch film according to claim 1, wherein the higher density m-LLDPE is comprised of a higher alpha-olefin comonomer.

14. A cast power stretch film comprised of five layers, the film having a total film thickness, wherein a discrete layer is comprised of a higher density m-LLDPE.

15. The cast power stretch film according to claim 14, wherein the higher density m-LLDPE is blended with resins chosen from the group consisting of polyethylenes, polyethylene copolymers, polypropylenes, and polypropylene copolymers.

16. The cast power stretch film according to claim 14, wherein the discrete layer has a thickness ranging from 5 to 70 percent of the total film thickness.

17. The cast power stretch film according to claim 16, wherein the discrete layer has a thickness of approximately 32 percent of the total film thickness.

18. The cast power stretch film according to claim 14, wherein the higher density m-LLDPE has a melt index ranging from 0.5 to 8.0 (g/10 min. @ 190° C./2.16 kg).

19. The cast power stretch film according to claim 18, wherein the higher density m-LLDPE has a melt index ranging from 1.0 to 3.0 (g/10 min. @ 190° C./2.16 kg).

20. The cast power stretch film according to claim 18, wherein the higher density m-LLDPE has a melt index of approximately 2.0 (g/10 min. @ 190° C./2.16 kg).

21. The cast power stretch film according to claim 14, wherein the higher density m-LLDPE has a density ranging from 0.900 g/cm³ to 0.960 g/cm³.

22. The cast power stretch film according to claim 21, wherein the higher density m-LLDPE has a density ranging from 0.922 g/cm³ to 0.940 g/cm³.

23. The cast power stretch film according to claim 21, wherein the higher density m-LLDPE has a density of approximately 0.925 g/cm³.

24. The cast power stretch film according to claim 14, wherein the higher density m-LLDPE is comprised of a higher alpha-olefin comonomer.

25. The cast power stretch film according to claim 14, wherein the film is comprised of:
a layer comprised of ZN-catalyzed LLDPE, with a thickness of approximately 10 percent of the total film thickness;
a layer comprised of conventional m-LLDPE, with a thickness of approximately 32 percent of the total film thickness;
a layer comprised of ZN-catalyzed LLDPE, with a thickness of approximately 16 percent of the total film thickness;
a layer comprised of higher density m-LLDPE, with a thickness of approximately 32 percent of the total film thickness; and
a layer comprised of ZN-catalyzed LLDPE, with a thickness of approximately 10 percent of the total film thickness.
